(19) United States
(12) Patent Application Publication
(10) Pub. No.: US 2009/0184113 A1
(43) Pub. Date: Jul. 23, 2009

(54) PACKING CRATE ASSEMBLY

(76) Inventor: Richard Freeman Smith, III, Chula Vista, CA (US)

Correspondence Address: NYDEGGER & ASSOCIATES, 348 OLIVE STREET, SAN DIEGO, CA, 92103, US

(21) Appl. No.: 12/018,579

(22) Filed: Jan. 23, 2008

(51) Int. Cl. B65D 88/00; B23P 19/04

(52) U.S. Cl. 220/1.5; 29/700

(57) ABSTRACT

A packing crate having a first, expanded configuration and a second, compact configuration is disclosed. In the first configuration, the crate is formed by a floor assembly and a seal that are interconnected by an upright assembly. In the second configuration, the floor assembly and seal are directly connected to form a chamber for housing the disassembled upright assembly. Structurally, the floor assembly includes a rectangular floor panel with four side edges and four floor braces. Further, the upright assembly includes four rectangular upright panels and four corner braces for bracing each interface between the upright panels in the first configuration. Also, the seal includes a rectangular seal panel and four seal braces.

### FIELD OF THE INVENTION

The present invention pertains generally to packing crate assemblies and methods used to assemble packing crates. More particularly, the present invention pertains to packing crate assemblies that provide crates capable of being converted between an expanded configuration for receiving and shipping goods and a compact configuration that facilitates storage. The present invention is particularly, but not exclusively, useful for providing lightweight, structurally sound packing crates that are easy to assemble and disassemble.

### BACKGROUND OF THE INVENTION

In virtually every business, there is a need for storage containers to receive, ship, and store various items. Typically, corrugated cardboard boxes are used for shipping and storing most goods. While cardboard boxes offer only limited protection from shipping damage, their low cost, familiarity and availability make them popular. While in transit, however, boxes will often undergo extreme stresses due to shifting of cargo, to shocks to the vehicle carrying the cargo, or to vibrations regularly imparted by the cargo carrying vehicle. Such stresses often damage the items inside the boxes. In order to avoid the potential of such damage, the boxes are typically filled with packing material such as Styrofoam peanuts, or popcorn, or similar filler. These packing materials are somewhat effective because the boxes allow forces to act through their top panels onto their internal spaces. In other words, the vertical walls of a box do not support the weight of boxes stacked above the box. Nevertheless, when packing materials are used, the packed items are occasionally damaged and the boxes are often damaged. Damage to the shipping boxes prevents their subsequent use for returning products or for other purposes.

In addition to their lack of structural strength, typical cardboard shipping boxes require a large volume of space for storage when not in use. Specifically, due to the method of assembly for cardboard boxes, i.e., adhesive tape, most cardboard boxes are damaged and weakened when disassembled. Therefore, after their initial assembly, such boxes are typically kept in their assembled condition and are stacked until needed. As a result, the boxes can take up space that may otherwise be put to productive use.

In light of the above, it is an object of the present invention to provide a packing crate which provides improved balance and structural strength. Another object of the present invention is to provide a packing crate having a first expanded configuration and a second compact configuration. Yet another object of the present invention is to provide a packing crate that utilizes lightweight panels and structurally sound braces. Still another object of the present invention is to provide a packing crate that supports a stack of multiple crates through its external bracing. Another object of the present invention is to provide a packing crate that is easy to use, is simple to assemble, and is comparatively cost effective.

### SUMMARY OF THE INVENTION

In accordance with the present invention, a packing crate having a first, expanded configuration and a second, compact configuration is provided. As a result of its multiple configurations, the packing crate minimizes the storage area needed when not in use. Further, the packing crate optimizes structural strength while reducing weight due to the use of an exoskeleton surrounding lightweight panels.

Structurally, the packing crate includes a floor assembly including a substantially rectangular floor panel having four side edges. Further, the floor assembly includes four floor braces. For connection with the floor panel, each floor brace forms a groove to receive a respective side edge of the floor panel.

Also, the packing crate comprises a seal including a substantially rectangular seal panel with four panel edges. Adjacent each panel edge, a seal brace is bonded or otherwise fixed to the seal panel. In the first configuration, the seal braces of the seal are connected to the floor braces of the floor assembly. As a result, a chamber is formed between the floor panel and the seal panel.

Within the chamber, the packing crate includes an upright assembly in a disassembled state. Specifically, the upright assembly includes four rectangular upright panels and four L-shaped corner braces. When the seal is disconnected from the floor assembly and the upright assembly is removed from the chamber, the upright panels may be aligned with the side edges of the floor panel. As a result, four interfaces are formed between the four upright panels. In order to stabilize the upright assembly, a corner brace is connected to the upright panels at each interface. Further, the corner braces are connected to the floor braces. In order to close the packing crate, the seal braces are connected to the corner braces. As a result, the packing crate forms an enclosure using lightweight panels and an exoskeleton of braces.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the packing crate of the present invention in a first, expanded configuration, in accordance with an embodiment of the present invention;

FIG. 2 is a perspective view of the packing crate of FIG. 1 in a second, compact configuration, in accordance with an embodiment of the present invention;

FIG. 3 is an exploded perspective view of the floor assembly of the packing crate shown in FIG. 1;

FIG. 4 is an exploded perspective view of the upright assembly of the packing crate shown in FIG. 1;

FIG. 5A is a perspective view of the topside of the seal of the packing crate shown in FIG. 1;

FIG. 5B is a perspective view of the underside of the seal of the packing crate shown in FIG. 5A;

FIG. 6 is a perspective view of the floor assembly and upright assembly of a packing crate in accordance with another embodiment of the present invention;

FIG. 7 is a perspective view of the seal of a packing crate for use with the embodiment shown in FIG. 6; and

FIG. 8 is a cross sectional view of the seal as seen along line 8-8 in FIG. 7.

### DESCRIPTION OF THE PREFERRED EMBODIMENTS

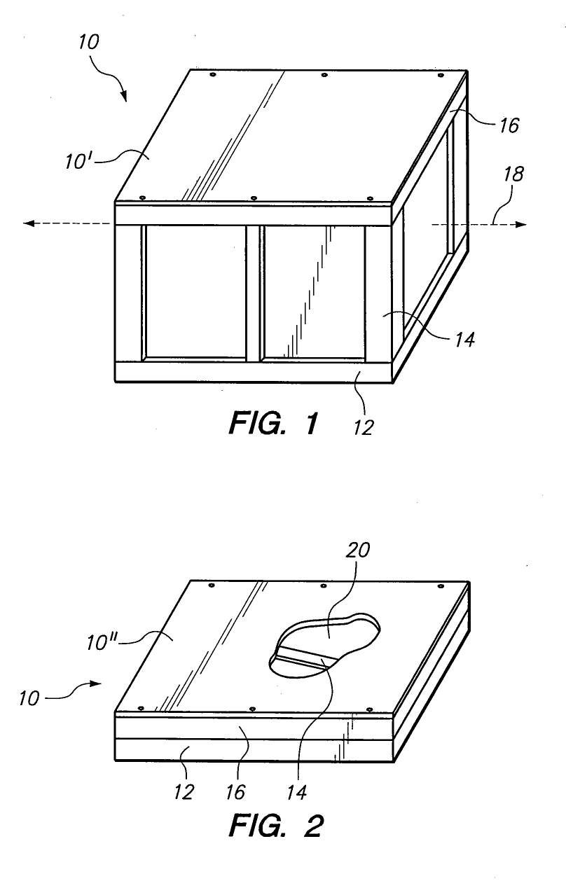

Referring initially to FIG. 1, a packing crate, generally designated 10, is shown in its first, expanded configuration 10′, in accordance with the present invention. Structurally, the packing crate 10 includes a floor assembly 12, an upright assembly 14 and a seal 16. In the first configuration 10′, the upright assembly 14 interconnects the floor assembly 12 and the seal 16 and defines a crate axis 18. Referring to FIG. 2, it can be seen that the packing crate 10 also has a second configuration 10″. In the second configuration 10″, the floor assembly 12 is connected directly to the seal 16. With this connection, a chamber 20 is formed between the floor assembly 12 and the seal 16. Further, in the second configuration 10″, the upright assembly 14 is disassembled and stored in the chamber 20.

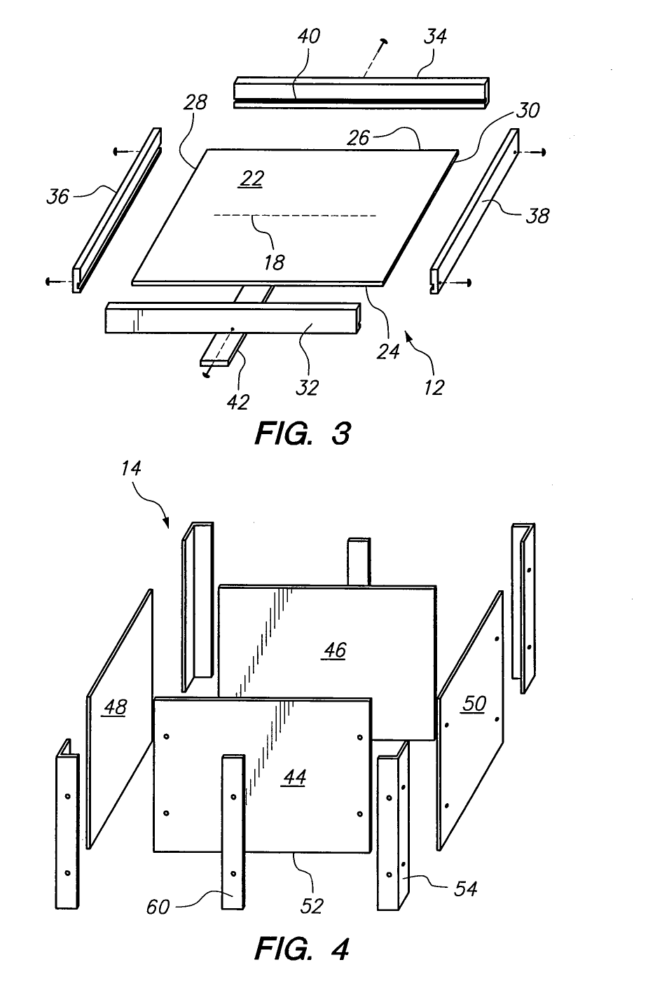

Referring to FIG. 3, the structure of the floor assembly 12 is more clearly shown. As shown, the floor assembly 12 includes a substantially rectangular floor panel 22. Specifically, the floor panel 22 is planar and has a first side edge 24 opposite from a second side edge 26. As shown, each side edge 24, 26 is parallel to the crate axis 18. Further, the floor panel 22 includes a proximal end edge 28 and an opposite distal end edge 30 that are both perpendicular to the crate axis 18. In addition, the floor assembly 12 includes a first side brace 32, a second side brace 34, a proximal end brace 36 and a distal end brace 38. In order to facilitate connection with the floor panel 22, each brace 32, 34, 36, 38 is formed with a groove 40 to receive a respective edge 24, 26, 28, 30 of the floor panel 22. Also, the floor assembly 12 includes a floor panel brace 42 that interconnects the first and second side braces 32, 34 and further supports the floor panel 22.

Referring now to FIG. 4, the structure of the upright assembly 14 may be understood. As shown, the upright assembly 14 includes a first side panel 44, a second side panel 46, a proximal end panel 48 and a distal end panel 50. Further, each panel 44, 46, 48, 50 is planar and substantially rectangular. Also, the side panels 44, 46 are parallel to one another and perpendicular to the end panels 48, 50. Cross referencing FIG. 4 with FIGS. 1 and 3, it can be seen that each panel 44, 46, 48, 50 includes a floor edge 52 for abutting the floor panel 22 and the respective brace 32, 34, 36, 38 in the first configuration 10′.

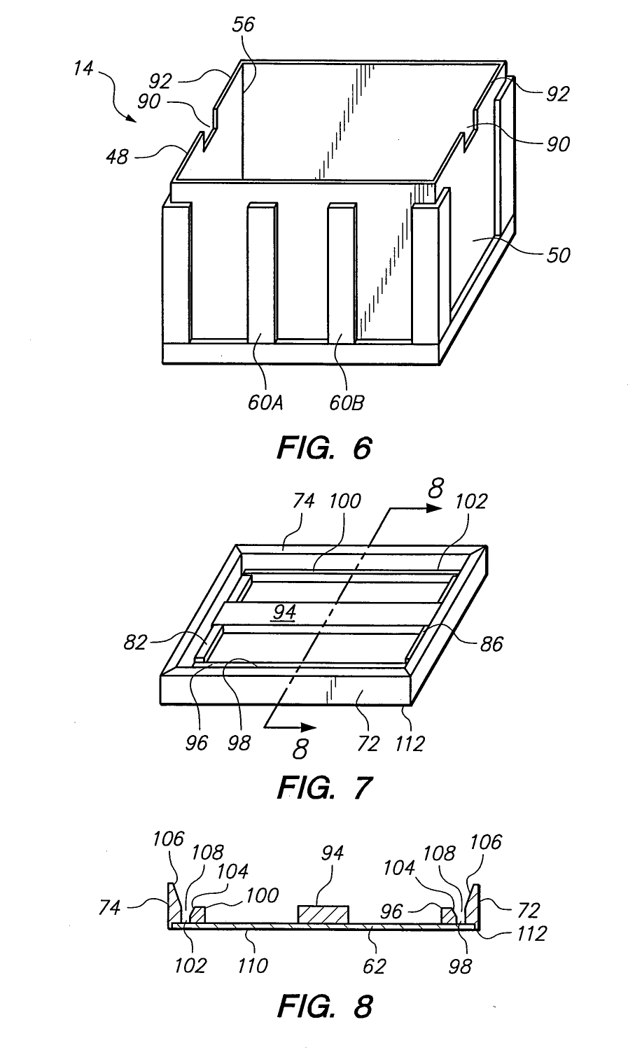

As shown in FIG. 4, the upright assembly 14 further includes four L-shaped corner braces 54 for bracing each interface 56 (see FIG. 6) between adjacent panels 44, 46, 48, 50 in the first configuration 10′. Also, the upright assembly 14 may include one or more side panel braces 60 for supporting each respective side panel 44, 46. Specifically, each side panel brace 60 is parallel to, and positioned between, two adjacent corner braces 54.

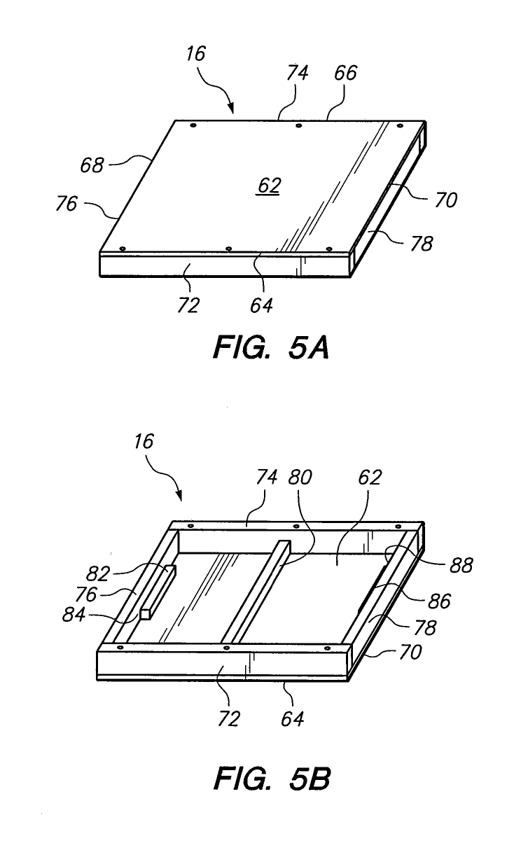

Referring to FIGS. 5A and 5B, the structure of the seal 16 is illustrated. As shown, the seal 16 includes a planar, substantially rectangular seal panel 62 that has a first side edge 64 and an opposite second side edge 66 that are parallel to the axis 18 (see FIG. 1). Further, the seal panel 62 has a proximal end edge 68 and an opposite distal end edge 70 that are perpendicular to the axis 18 (see FIG. 1). Also, the seal 16 includes a first side seal brace 72 and a second side seal brace 74 that are bonded to the seal panel 62 along the side edges 64, 66, respectively. Further, the seal 16 includes a proximal end seal brace 76 and a distal end seal brace 78 that are bonded to the seal panel 62 along the end edges 68, 70, respectively. As shown in FIG. 5B, the seal 16 includes at least one seal panel brace 80 interconnected between the side seal braces 72, 74 and parallel to the end seal braces 76, 78. Also, the seal 16 includes a proximal end guide member 82 positioned adjacent the proximal end seal brace 76 to form a proximal end gap 84. Further, the seal 16 includes a distal end guide member 86 positioned adjacent the distal end seal brace 78 to form a distal end gap 88. In the first configuration 10′ shown in FIG. 1, the gaps 84, 88 receive the proximal end panel 48 and the distal end panel 50 of the upright assembly 14, respectively. As seen in FIG. 1, in the first configuration 10′, the upright assembly 14 interconnects the floor assembly 12 and the seal 16. As shown in FIG. 2, in the second configuration 10″, the floor assembly 12 and the seal 16 are connected directly together.

Referring now to FIG. 6, an alternate embodiment of the upright assembly 14 is shown. In FIG. 6, the upright assembly 14 includes two side panel braces 60a and 60b. Further, each end panel 48, 50 includes a notch 90 along its upper edge 92. The relevance of the notch 90 can be seen when considering FIG. 7. In FIG. 7, the seal 16 includes a seal panel brace 94 that extends between the end seal braces 76, 78 to support the seal panel 62. In order to properly engage the seal 16 and the upright assembly 14 of FIG. 6, the notch 90 receives the seal panel brace 94.

As further shown in FIG. 7, in addition to the end guide members 82, 86, the seal 16 includes a first side guide member 96. As shown, the first side guide member 96 is positioned adjacent the first side seal brace 72 to form a first side gap 98. Further, the seal 16 includes a second side guide member 100 positioned adjacent the second side seal brace 74 to form a second side gap 102. When the seal 16 of FIG. 7 and upright assembly 14 of FIG. 6 are assembled to form the first configuration 10′ of the crate 10, the gaps 98, 102 receive the first side panel 44 and the second side panel 46 of the upright assembly 14, respectively.

Cross-referencing FIGS. 7 and 8 illustrate an additional feature related to the guide members 82, 86, 96, 100 and gaps 84, 88, 98, 102. Specifically, each guide member 82, 86, 96, 100 is tapered by about 4.5 degrees to facilitate movement of the respective side panel 44, 46 and end panel 48, 50 into the respective gap 84, 88, 98, 102 to position the crate 10 in the first configuration 10′. For the same reason, each seal brace 72, 74, 76, 78 is tapered 4.5 degrees. As exemplified in FIG. 8, each guide member 82, 86, 96, 100 includes a tapered surface 104 and each seal brace 72, 74, 76, 78 includes a tapered surface 106. As a result, the entrance 108 to each gap 84, 88, 98, 102 is widened to facilitate engagement with the upright assembly 14. Also, as shown in FIG. 8, the seal panel 62 is inlayed with respect to the seal braces 72, 74, 76, 78. Specifically, the outer surface 110 of the seal panel 62 is contiguous with the top surfaces 112 of the seal braces 72, 74, 76, 78. As a result, when packing crates 10 are stacked on one another, the seal braces 72, 74, 76, 78 of a packing crate 10 contact the floor braces 32, 34, 36, 38 of the above crate 10 to support its weight.

Commercially, the packing crate 10 may be sold, delivered and stored in the second configuration 10″. When needed, the crate 10 may be assembled by disconnecting the seal 16 from the floor assembly 12. Then, the upright assembly 14 is removed from the chamber 20 and is connected to the floor assembly 12 as shown in FIG. 6. Thereafter, the crate 10 may be used to store other items, and then closed with the seal 16.

For the packing crate 10, the braces, including 32, 34, 36, 38, 54, 72, 74, 76, 78, may be formed from wood, plastic, metal or other material offering structural strength at reasonable densities. Further, the panels, including 22, 44, 46, 48, 50, 62, may be comprised of lightweight wood, cardboard, metal or other lightweight material without substantial regard for structural strength. Permanent connections, as between the seal panel 62 and braces 72, 74, 76, 78, 80 may be performed by glue, hot plastic or other bonding agent. On the other hand, connections that are intended to be reversible, such as between the upright assembly 14 and the floor assembly 12, and between the upright assembly 14 and seal 16, are appropriately handled with conventional screws or similar fasteners.

As a result of the cooperation of its structure, the packing crate 10 offers increased strength while having a decreased weight. For instance, a six pound packing crate 10 can easily support over 3000 pounds. Structurally, the exoskeleton created by the braces 32, 34, 36, 38, 54, 72, 74, 76, 78 serve to protect the panels 22, 44, 46, 48, 50, 62 and the contents of the crate 10. As a result, the panels 22, 44, 46, 48, 50, 62 themselves may be quite lightweight without concern for structural strength. Further, the packing crate 10 offers reduced space necessary for storage due to its compact size in the second configuration 10″. In certain preferred embodiments, the packing crate 10 has a width of 20 inches and a length of 24 inches. With these dimensions, four packing crates 10 can be arranged on a typical 40 inch by 48 inch pallet.

While the particular Packing Crate Assembly as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A packing crate having a first configuration and a second configuration comprising:
a floor assembly including (a) a rectangular floor panel with four side edges, and (b) four floor braces, with each floor brace being formed with a groove to receive a respective side edge;
an upright assembly including (a) four rectangular upright panels, with each upright panel having a floor edge for abutting the floor panel adjacent the respective side edge in the first configuration, and (b) four corner braces for bracing each interface between the upright panels in the first configuration; and
a seal including (a) a rectangular seal panel with four panel edges, and (b) four seal braces, with each seal brace fixed to the seal panel adjacent a respective edge, wherein, in the first configuration, the upright assembly interconnects the floor assembly and the seal, and wherein, in the second configuration, the floor assembly and the seal are connected directly together to form an internal chamber housing the upright assembly.

2. A crate as recited in claim 1 wherein the floor assembly further includes at least one floor panel brace interconnected between two opposite floor braces and parallel to two-opposite floor braces.

3. A crate as recited in claim 1 wherein the upright assembly further includes at least one upright panel brace to support at least one selected side panel, wherein each upright panel brace is parallel to and positioned between two adjacent corner braces.

4. A crate as recited in claim 1 wherein the seal further includes at least one seal panel brace interconnected between two opposite seal braces and parallel to two opposite seal braces.

5. A crate as recited in claim 1, wherein the seal further comprises four guide members, with each guide member being positioned adjacent a respective seal brace to form a gap between the guide member and the respective seal brace for receiving a respective upright panel in the first configuration.

6. A crate as recited in claim 5 wherein each guide member is tapered to facilitate movement of the respective upright panel into the respective gap to position the crate in the first configuration.

7. A crate as recited in claim 6 wherein each seal brace is tapered to facilitate movement of the respective upright panel into the respective gap to position the crate in the first configuration.

8. A packing crate defining a longitudinal axis and having a first configuration and a second configuration comprising:
a floor assembly including (a) a floor panel with opposite first and second side edges parallel to the axis and opposite proximal and distal end edges perpendicular to the axis, (b) first and second side braces, with each side brace formed with a groove to receive a respective side edge of the floor panel, and (c) proximal and distal end braces, with each end brace formed with a groove to receive a respective end edge of the floor panel;
an upright assembly including (a) first and second side panels, with each side panel having a floor edge parallel to the axis for abutting the floor panel and the respective side brace in the first configuration, (b) proximal and distal end panels, with each end panel having a floor edge perpendicular to the axis for abutting the floor panel and the respective end brace in the first configuration, and (c) four L-shaped corner braces for bracing each interface between the side panels and the end panels in the first configuration; and
a seal including (a) a seal panel with opposite first and second side edges parallel to the axis and opposite proximal and distal end edges perpendicular to the axis, (b) a first side seal brace and a second side seal brace, and (c) a proximal end seal brace and a distal end seal brace, wherein, in the first configuration, the upright assembly interconnects the floor assembly and the seal, and wherein, in the second configuration, the floor assembly and the seal are connected directly together to form an internal chamber housing the upright assembly.

9. A crate as recited in claim 8 wherein the floor assembly further includes at least one floor panel brace interconnected between the side braces and parallel to the end braces.

10. A crate as recited in claim 8 wherein the upright assembly further includes at least one side panel brace to support each side panel, wherein each side panel brace is parallel to and positioned between two adjacent corner braces.

11. A crate as recited in claim 8 wherein the seal further includes at least one seal panel brace interconnected between the side seal braces and parallel to the end seal braces.

12. A crate as recited in claim 8, wherein the seal further comprises:
a first side guide member positioned adjacent the first side seal brace to form a first side gap for receiving the first side panel in the first configuration;
a second side guide member positioned adjacent the second side seal brace to form a second side gap for receiving the second side panel in the first configuration;
a proximal end guide member positioned adjacent the proximal end seal brace to form a proximal end gap for receiving the proximal end panel in the first configuration; and
a distal end guide member positioned adjacent the distal end seal brace to form a distal end gap for receiving the distal end panel in the first configuration.

13. A crate as recited in claim 12 wherein each guide member is tapered to facilitate movement of the respective side panel and end panel into the respective gap to position the crate in the first configuration.

14. A crate as recited in claim 13 wherein each seal brace is tapered to facilitate movement of the respective side panel and end panel into the respective gap to position the crate in the first configuration.

15. A method for preparing a packing crate comprising the steps of:
providing a crate assembly in a compact configuration including (a) a floor assembly including a rectangular floor panel with four side edges and four floor braces, with each floor brace formed with a groove to receive a respective side edge, (b) a seal including a rectangular seal panel with four panel edges, and four seal braces, wherein each seal brace is fixed to the seal panel adjacent a respective edge, and wherein each seal brace is connected to a respective floor brace to form a chamber between the floor panel and the seal panel, and (c) an upright assembly stored within the chamber and including four rectangular upright panels and four corner braces;
disconnecting the seal from the floor assembly;
removing the upright assembly from the chamber;
connecting the upright assembly to the floor assembly by (a) abutting a floor edge of each upright panel to a respective side edge on the floor panel to form an interface between each adjacent upright panel, and (b) bracing each interface between the upright panels with a corner brace; and
mounting the seal on the upright assembly to establish the crate assembly in an expanded configuration.

16. A method as recited in claim 15 wherein the floor assembly further includes at least one floor panel brace, and wherein the connecting step includes the step of interconnecting the floor panel between two opposite floor braces and parallel to two opposite floor braces.

17. A method as recited in claim 15 wherein the seal further includes at least one seal panel brace interconnected between two opposite seal braces and parallel to two opposite seal braces.

18. A method as recited in claim 15, wherein the seal further comprises four guide members, with each guide member being positioned adjacent a respective seal brace to form a gap between the guide member and the respective seal brace for receiving a respective upright panel during the mounting step.

19. A method as recited in claim 18 wherein each guide member is tapered to facilitate movement of a respective upright panel into the respective gap during the mounting step.

20. A method as recited in claim 19 wherein each seal brace is tapered to facilitate movement of a respective upright panel into the respective gap during the mounting step.
